(19) United States
(12) Patent Application Publication
(10) Pub. No.: US 2020/0398839 A1
(43) Pub. Date: Dec. 24, 2020

(54) Communication Control Apparatus, Communication Control Method, and Preceding Vehicle Following System

(71) Applicant: Hitachi Automotive Systems, Ltd., Hitachinaka-shi, Ibaraki (JP)

(72) Inventors: Hiroshi ITO, Isehara-shi, Kanagawa (JP); Kentaro UENO, Atsugi-shi, Kanagawa (JP); Hiroki SUGAWARA, Sagamihara-shi, Kanagawa (JP)

(21) Appl. No.: 16/968,781

(22) PCT Filed: Jan. 7, 2019
(86) PCT No.: PCT/JP2019/000070

§ 371 Date: Aug. 10, 2020

(30) Foreign Application Priority Data
Feb. 23, 2018 (JP) 2018-030544

(51) Int. Cl. B60W 30/165; H01Q 3/24; H01Q 3/04; H04B 7/06; H04W 4/46

(52) U.S. Cl. CPC B60W 30/165; H01Q 3/24; B60W 2556/65; H04B 7/06; H04W 4/46; H01Q 3/04

(57) ABSTRACT

A communication control apparatus is configured to be mounted on a first vehicle in a preceding vehicle following system that performs follow control by non-mechanically connecting the first vehicle and a second vehicle. The communication control apparatus is configured to cause radio wave radiation of an antenna of the first vehicle to have directionality toward an antenna of the second vehicle based on input relative position information between the second vehicle and the first vehicle.

### TECHNICAL FIELD

The present invention relates to a communication control apparatus and a communication control method in a preceding vehicle following system that follows a preceding vehicle by non-mechanically connecting a preceding vehicle and a following vehicle.

### BACKGROUND ART

Communication control apparatuses on moving objects come in various types, and, for example, the technique disclosed in PTL 1 is known as one of them. PTL 1 presents a disclosure regarding communication between a moving object communication apparatus including a reception means capable of controlling the directionality of an antenna and used to receive a predetermined radio wave, and a fixed base station.

### CITATION LIST

### Patent Literature

[PTL 1] Japanese Patent Application Public Disclosure No. 2006-80669

### SUMMARY OF INVENTION

### Technical Problem

PTL 1 is a communication method between the moving object communication apparatus and the fixed base station, and does not take into consideration a communication method between moving objects in follow control, such as communication in a preceding vehicle following system that performs following a preceding vehicle by non-mechanically connecting a preceding vehicle and a following vehicle. Generally, inter-vehicle communication, which is the communication between moving objects, is carried out in the form of broadcast communication addressing a plurality of vehicles, and therefore uses a widely directional (non-directional) antenna and performs the CSMA/CA access control, thereby being susceptible to the influence of interference from a communication apparatus functioning in the same frequency band, such as another vehicle and a roadside unit present in a range where radio waves are reachable. This circumstance leads to the generation of a delay time due to a waiting time for avoiding communication collision, and one conceivable measure against it is to reduce the radio-wave radiation angle to a narrow angle.

However, there is raised a problem that the partner vehicle may move out from the range in which radio waves are radiated in follow control at a short distance and along a small-radius trajectory, as a problem specific to the follow control.

### Solution to Problem

One of objects of the present invention is to provide a communication control apparatus, a communication control method, and a preceding vehicle following system that allow an excellent communication state to be acquired regardless of the relative position between the vehicles in the follow control.

According to one exemplary aspect of the present invention, a communication control apparatus is configured to be mounted on a first vehicle in a preceding vehicle following system that performs follow control by non-mechanically connecting the first vehicle and a second vehicle. The communication control apparatus is configured to cause radio wave radiation of an antenna of the first vehicle to have directionality toward an antenna of the second vehicle based on input relative position information between the second vehicle and the first vehicle.

According to the one aspect of the present invention, the excellent communication state can be acquired regardless of the relative position between the vehicles in the follow control.

### BRIEF DESCRIPTION OF DRAWINGS

FIGS. 1(A) and (B) illustrate a problem and a solution therefor in a preceding vehicle following system according to an embodiment.

FIGS. 2(A) and (B) illustrate an example of a configuration of electronic directionality control according to the embodiment.

FIG. 3 illustrates an example of a configuration of physical directionality control according to the embodiment.

FIG. 4 is a block diagram of a configuration of the preceding vehicle following system according to the embodiment.

FIG. 5 is a block diagram of another configuration of the preceding vehicle following system according to the embodiment.

### DESCRIPTION OF EMBODIMENTS

In the following description, an embodiment of the present invention will be described in detail with reference to the drawings.

### Embodiment

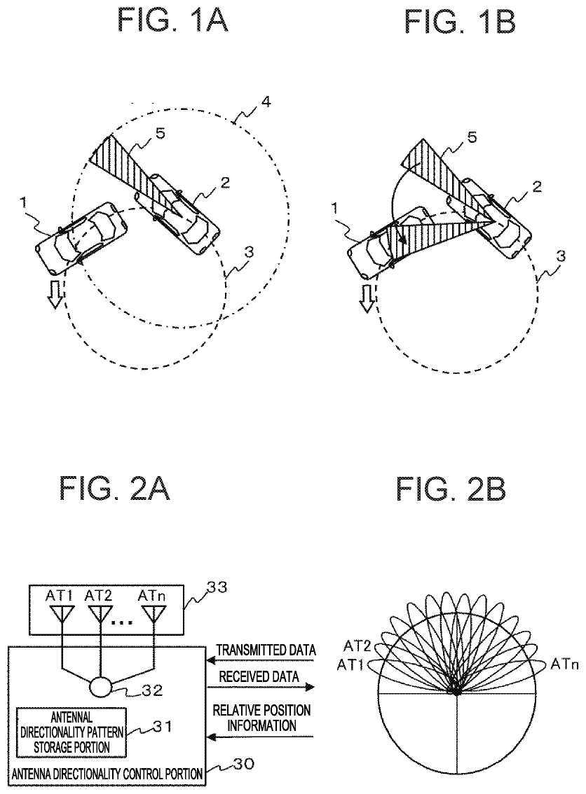

FIGS. 1(A) and (B) illustrate a problem and a solution therefor in a preceding vehicle following system according to the present embodiment.

In FIG. 1(A), 1 and 2 denote a preceding vehicle and a following vehicle running while following behind the preceding vehicle 1 in the preceding vehicle following system, respectively. In FIG. 1(A), the directionality of an antenna of a communication apparatus on the following vehicle 2 makes the communication susceptible to the influence of interference from another communication apparatus if an antenna used as it is a general non-directional antenna having wide directionality indicated by 4 in FIG. 1(A). Therefore, one conceivable measure against it is to use a narrow directional antenna that radiates radio waves at a reduced narrow angle, which is indicated by 5 in FIG. 1(A). However, when the follow control is attempted as indicated by a white arrow in FIG. 1(A) at a short distance between the vehicles and along a small-radius trajectory 3 in the follow control, there is raised a problem that the narrow directional antenna on the following vehicle 2 undesirably causes the preceding vehicle 1 to move out from the radio-wave radiation range.

Therefore, in the present embodiment, the preceding vehicle following system is configured to cause the radio-wave radiation direction of the communication apparatus on the following vehicle 2 to have directionality toward the preceding vehicle 1 as indicated by a solid arrow in FIG. 1(B) based on relative position information, which is information about a relative distance, a relative speed, and a relative angle between the preceding vehicle 1 and the following vehicle 2 as illustrated in FIG. 1(B), i.e., is configured to dynamically variably control the radio-wave radiation direction. As a result, the preceding vehicle following system can prevent or reduce the influence of interference from another communication apparatus and acquire an excellent communication state regardless of the relative position between the vehicles in the preceding vehicle following system. The method for dynamically varying the directionality may be an electronic method like switching a plurality of differently directional antennas based on the relative position information or may be a mechanism including a physical movable portion.

FIGS. 2(A) and (B) illustrate an example of a configuration of the electronic directionality control according to the embodiment. In FIG. 2(A), a directional antenna 33 includes a plurality of differently directional element antennas AT1 to ATn. An antenna directionality control portion 30 includes an antenna directionality pattern storage portion 31, which stores therein a directionality pattern of the antenna, and includes an antenna switching portion 32, which selects and switches an antenna directional in the direction toward the partner vehicle based on the relative position information. Examples of the antenna including a plurality of differently directional element antennas include an array antenna. FIG. 2(B) illustrates an example of an antenna radiation pattern and indicates a radiation pattern of each of the element antennas AT1 to ATn, and the preceding vehicle following system may select an element antenna directional in the direction toward the partner vehicle or may use a radiation pattern defined by selecting, combining, and merging a plurality of element antennas. According thereto, the present embodiment allows the preceding vehicle following system to adjust the range in which radio waves are radiated with use of the combination of selected element antennas, thereby allowing the preceding vehicle following system to excellently transmit the relative position information of this vehicle itself toward the partner vehicle even under an environment that radio wave signals are weak. Such an electronic directionality control portion is characterized by being highly durable because of the absence of a movable portion such as a rotational mechanism and being also flexible in terms of the antenna mountability.

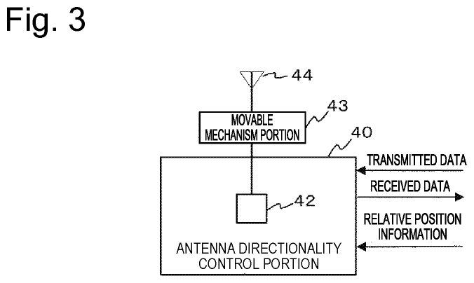

FIG. 3 illustrates an example of a configuration of the physical directionality control according to the embodiment. In FIG. 3, a directional antenna 44 includes a movable mechanism portion 43 such as a motor and an antenna rotational angle control portion 42, and rotates the antenna in a direction toward the partner vehicle based on the relative position information.

The present embodiment has been described regarding wireless communication, but is also applicable to visible light communication. The present embodiment is applicable to the visible light communication by movably adjusting an optical axis of a transmitter and a receiver. More specifically, the visible light communication requires LED light to be received while being collected on a lens having a narrow view angle to avoid the influence of ambient light, which raises the necessity of physical control of a swing mechanism (an adjustment of the optical axis) or the like for turning the lens in a direction toward the LED in the case of a moving object like a vehicle.

Such a physical directionality control portion is characterized by being simply configured compared to the complicatedly structured array antenna, thereby being able to be realized at low cost.

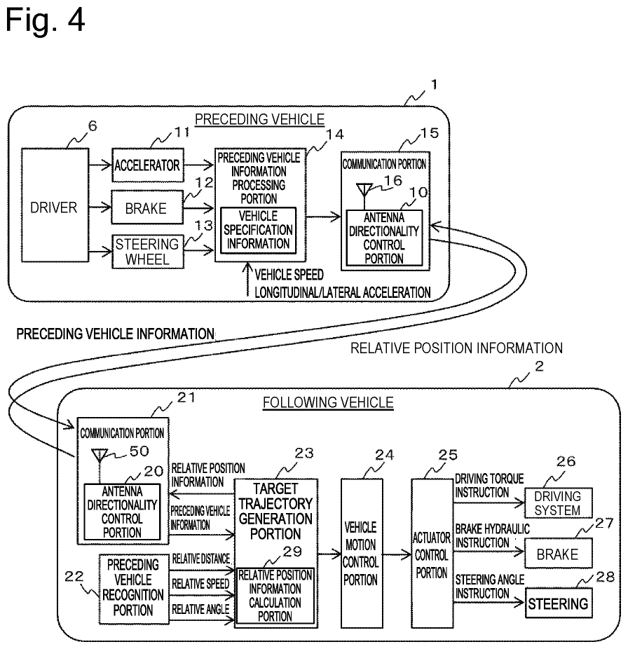

FIG. 4 is a block diagram of a configuration of the preceding vehicle following system according to the embodiment. In FIG. 4, the preceding vehicle 1 includes a preceding vehicle information processing portion 14 and a communication portion 15. The preceding vehicle information processing portion 14 processes preceding vehicle information including operation information indicating operation amounts of an accelerator 11, a brake 12, and a steering wheel 13 operated by a driver 6, a running state amount such as a vehicle speed and an acceleration, vehicle specification information, and the like. The communication portion 15 transmits the preceding vehicle information. Further, the communication portion 15 includes an antenna directionality control portion 10, which is any of the electronic antenna directionality control portion 30 and the physical antenna directionality control portion 40 described with reference to FIGS. 2 and 3, and a directional antenna 16.

The following vehicle 2 includes a communication portion 21, a preceding vehicle recognition portion 22, a target trajectory generation portion 23, a vehicle motion control portion 24, and an actuator control portion 25. The communication portion 21 receives the preceding vehicle information transmitted from the preceding vehicle 1. The preceding vehicle recognition portion 22 acquires preceding vehicle recognition information such as the relative distance, the relative speed, and the relative angle to the preceding vehicle 1. The target trajectory generation portion 23 generates a target trajectory that follows behind the running trajectory of the preceding vehicle based on the received preceding vehicle information and the information acquired by the preceding vehicle recognition portion 22. The vehicle motion control portion 24 calculates a control instruction for the vehicle motion of the following vehicle 2 itself so as to achieve the follow control according to the target trajectory. The actuator control portion 25 calculates and outputs control amounts of a driving system 26 such as an engine and a driving motor, a brake 27, and a steering wheel 28 regarding steering, braking, and driving according to the control instruction from the vehicle motion control portion 24.

Further, the target trajectory generation portion 23 includes a relative position information calculation portion 29. The relative position information calculation portion 29 calculates the relative position information, which is the information about the relative distance, the relative speed, and the relative angle between the preceding vehicle 1 and the following vehicle 2 itself. Then, the target trajectory generation portion 23 transmits the calculated relative position information to the preceding vehicle 1 via the communication portion 21. Further, the communication portion 21 includes an antenna directionality control portion 20, which is any of the electronic antenna directionality control portion 30 and the physical antenna directionality control portion 40 described with reference to FIGS. 2 and 3, and a directional antenna 50.

The antenna directionality control portion 20 of the following vehicle 2 dynamically variably controls the antenna radio-wave radiation direction of the directional antenna 50 of the communication portion 21 in such a manner that it has directionality toward the preceding vehicle 1 based on the relative position information calculated by the relative position information calculation portion 29. Further, the antenna directionality control portion 10 of the preceding vehicle 1 dynamically variably controls the antenna radio-wave radiation direction of the directional antenna 16 in such a manner that it has directionality toward the following vehicle 2 based on the relative position information transmitted from the communication portion 21 of the following vehicle 2.

The preceding vehicle recognition portion 22 may acquire the preceding vehicle recognition information via the inter-vehicle communication or may acquire the preceding vehicle recognition information by an external world recognition portion, which is a shape recognition device such as a stereo camera and a laser radar.

Further, the antenna directionality control portion is provided to each of the following vehicle and the preceding vehicle and is configured to dynamically variably control the antenna radio-wave radiation direction in such a manner that it has directionality toward the partner vehicle from each other in FIG. 4, but may be provided to only the following vehicle or only the preceding vehicle. Providing the antenna directionality control portion to both the following vehicle and the preceding vehicle is advantageous because this can make each of them directional in the direction toward the partner vehicle, thereby further enhancing the effect of preventing or reducing the interference with radio waves surrounding it. Further, for example, in a case where the follow control is performed with three or more vehicles connected, the present configuration allows the preceding vehicle to be directionally controlled toward the vehicle following behind it and the second and subsequent following vehicles to be directionally controlled toward the front vehicle.

Further, the present embodiment has been described assuming that the directional antenna and the antenna directionality control portion are included in the communication portion in the above description, but they may be provided as different portions from the communication portion. Externally providing them as different portions can bring about a similar effect independently of the system.

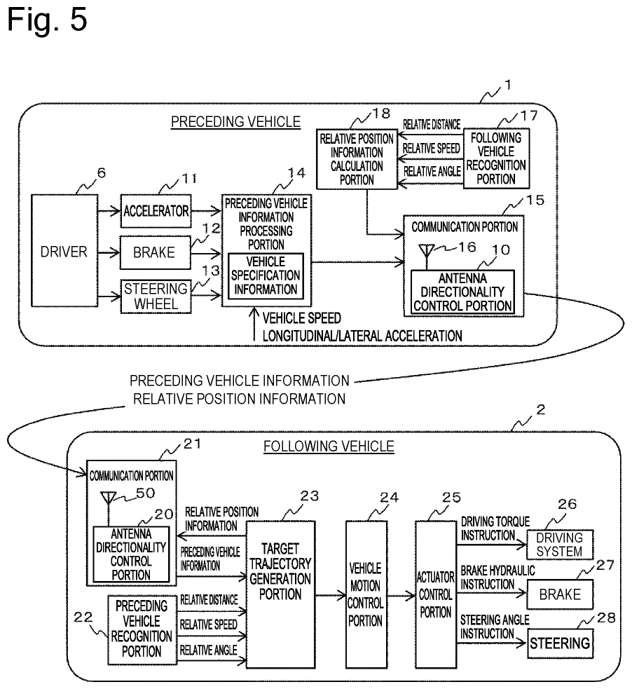

FIG. 5 is a block diagram of another configuration of the preceding vehicle following system according to the embodiment. In FIG. 5, functions similar to FIG. 4 will be identified by the same reference numerals, and descriptions thereof will be omitted. FIG. 5 is different from FIG. 4 in terms of the provision of a relative position information calculation portion to the preceding vehicle. In FIG. 5, the preceding vehicle 1 includes a following vehicle recognition portion 17 and a relative position information calculation portion 18. The following vehicle recognition portion 17 acquires following vehicle recognition information such as the relative distance, the relative speed, and the relative angle to the following vehicle 2. The relative position information calculation portion 18 calculates the relative position information between the following vehicle 2 and the preceding vehicle 1 itself. Then, the antenna directionality control portion 10 of the preceding vehicle 1 dynamically variably controls the antenna radio-wave radiation direction of the directional antenna 16 in such a manner that it has directionality toward the following vehicle 2 based on the calculated relative position information.

Further, the preceding vehicle information and the relative position information are transmitted from the preceding vehicle 1 to the following vehicle 2 via the communication portion 15. The following vehicle 2 dynamically variably controls the antenna radio-wave radiation direction of the directional antenna 50 of the communication portion 21 in such a manner that it has directionality toward the preceding vehicle 1 based on the relative position information transmitted from the preceding vehicle 1.

In this manner, the present embodiment can prevent or reduce the influence of interference from another communication apparatus by dynamically variably controlling the directionality of the directional antenna in such a manner that the antenna radio-wave radiation direction has directionality toward the partner vehicle according to the relative position information between the preceding vehicle and the following vehicle in the follow control by the preceding vehicle following system.

Having described the embodiment, the present invention is not limited to the above-described embodiment, and includes various modifications. For example, the above-described embodiment has been described in detail to facilitate a better understanding of the present invention, and the present invention is not necessarily limited to the configuration including all of the described features. Further, a part of the configuration of some embodiment can be replaced with the configuration of another embodiment, and some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2018-30544 filed on Feb. 23, 2018. The entire disclosure of Japanese Patent Application No. 2018-30544 filed on Feb. 23, 2018 including the specification, the claims, the drawings, and the abstract is incorporated herein by reference in its entirety.

### REFERENCE SIGN LIST

1: preceding vehicle
2: following vehicle
10, 20, 30, 40: antenna directionality control portion
15, 21: communication portion
16, 33, 44, 50: directional antenna
17: following vehicle recognition portion
18, 29: relative position information calculation portion
22: preceding vehicle recognition portion

1. A communication control apparatus configured to be mounted on a first vehicle in a preceding vehicle following system that performs follow control by non-mechanically connecting the first vehicle and a second vehicle,
wherein the communication control apparatus causes radio wave radiation of an antenna of the first vehicle to have directionality toward an antenna of the second vehicle based on input relative position information between the second vehicle and the first vehicle.

2. The communication control apparatus according to claim 1, wherein the communication control apparatus variably controls a direction of the radio wave radiation of the antenna of the first vehicle toward the second vehicle based on the relative position information.

3. The communication control apparatus according to claim 2, wherein the communication control apparatus variably controls the direction of the radio wave radiation by electronically changing the direction of the radio wave radiation.

4. The communication control apparatus according to claim 3, wherein the communication control apparatus variably controls the direction of the radio wave radiation by selectively combining a plurality of regularly arranged element antennas.

5. The communication control apparatus according to claim 2, wherein the communication control apparatus variably controls the direction of the radio wave radiation by physically rotating the antenna to thus change the direction of the radio wave radiation.

6. The communication control apparatus according to claim 1, wherein the second vehicle is a preceding vehicle and the first vehicle is a following vehicle following behind the preceding vehicle.

7. The communication control apparatus according to claim 6, wherein the relative position information is acquired by the following vehicle.

8. The communication control apparatus according to claim 1, wherein the relative position information is a relative distance, a relative speed, and a relative angle.

9. A communication control method configured to be performed on a first vehicle in a preceding vehicle following system that performs follow control by non-mechanically connecting the first vehicle and a second vehicle, the communication control method comprising:
causing radio wave radiation of an antenna of the first vehicle to have directionality toward an antenna of the second vehicle based on input relative position information between the second vehicle and the first vehicle.

10. The communication control method according to claim 9, further comprising variably controlling a direction of the radio wave radiation of the antenna of the first vehicle toward the second vehicle based on the input relative position information between the second vehicle and the first vehicle.

11. A preceding vehicle following system configured to perform follow control by non-mechanically connecting a first vehicle and a second vehicle, wherein the first vehicle includes
an external world recognition portion configured to recognize the second vehicle,
a relative position information calculation portion configured to acquire relative position information between the second vehicle recognized by the external world recognition portion and the first vehicle, and
a first communication control portion configured to cause radio wave radiation of an antenna of the first vehicle to have directionality toward an antenna of the second vehicle based on the relative position information.

12. The preceding vehicle following system according to claim 11, wherein the first communication control portion variably controls a direction of the radio wave radiation of the antenna of the first vehicle toward the second vehicle based on the relative position information.

13. The preceding vehicle following system according to claim 11, wherein the second vehicle includes a second communication control portion configured to cause radio wave radiation of the antenna of the second vehicle to have directionality toward the antenna of the first vehicle based on the relative position information.
